(19) United States
(12) Patent Application Publication
(10) Pub. No.: US 2007/0103111 A1
(43) Pub. Date: May 10, 2007

(54) Power Insert

(76) Inventors: William A Tower Jr., Raynham, MA (US); Stephen P Baptiste, Middleboro, MA (US)

Correspondence Address: WILLIAM ALBERT TOWER JR.;STEPHEN PAUL BAPTISTE, 5 BAKER RD., RAYNHAM, MA, 02767, US

(21) Appl. No.: 11/164,057

(22) Filed: Nov. 8, 2005

(51) Int. Cl. H02J 7/02

(52) U.S. Cl. 320/111

(57) ABSTRACT

The Power Insert Device provides a means for extending the operating time of a battery operated tool or device. Removal of the original battery from the tool or device being used and replacing OEM with the Power Insert accomplishes this. The said component is installed in the same manner as the original battery inserts into the tool, insuring a complete, secure, and uniform connection. The gradual loss of power that is normally associated with standard batteries is drastically reduced via a D.C. power plug, which mates to an external battery. The Power Insert also incorporates an overload safety device built into the base design for the protection of the tool it is powering. Battery insert transfers power to device or tool via an SJO cable that terminates into a D.C. male plug. One of the major innovations of this invention, including but not limited to, is the ability to fit into existing battery operated tools with no modifications to the power tool.

This invention relates to an adaptor plug and connector, which facilitates substitution of an external battery for the standard internal batteries which supply power to a hand held power tool. (i.e., cordless drills, reciprocating saws, circular saws, including various other portable tools, for which batteries are required for operation.)

As well recognized in the art, rechargeable batteries, such as those comprised of nickel-cadmium alloy, greatly reduce the need for replacement, but require frequent recharging. While sufficient for intermittent use, battery life shortens rapidly with continuous use, i.e. hand held power tools when such a tool is in frequent use. The reduction of available battery power results in annoying operating limitations that require more frequent battery replacement when the power tool is in use for extended periods of time.

Various devices exist for substituting power supplied by dry cell batteries including that illustrated in U.S. Pat. No. 3,308,419, which shows power supply featuring a battery shaped connector having helical contacts mounted thereon. Such a device however lacks means to guide and position same snugly within the housing confines of a power-operated tool. Devices such as those disclosed in U.S. Pat. No. 4,835,410 feature a combined corded and cordless system for power operated tools, but contemplate only internal batteries for supplying DC power source, rather than an external battery.

It is an important object of the invention to provide a hand held power tool capable of being powered either by internal batteries or alternatively by an external battery. Another important object of the invention is to provide an adaptor, which cooperates with the existing housing and maintains DC continuity. Another important object of the invention is to permit the substitution of alternative DC power for the internal batteries. Another important object of the invention is to provide an adaptor that includes vertically and longitudinally spaced members to guide and position the adaptor within the battery housing of hand held power tool.

### SUMMARY OF THE INVENTION

It has been found that a hand held power tool may be supplied with an adaptor, which facilitates substitution of power from an external DC power source. The adaptor is perfectly formed to the battery housing of the hand held power tool. Enclosed within the adaptor body member is an overcurrent device with contacts that protect the motor of the hand held power tool. Additionally, the adaptor is provided with a swivel interface connector that facilitates power from an external battery-to-battery housing device. The invention thereby allows for an external battery to be readily substituted for internal batteries in a hand-held power tool.

### BRIEF DESCRIPTION OF THE DRAWINGS

The construction designed to carry out the invention will be hereinafter described, together with other features thereof.

The invention will be more readily understood from a reading of the following specification and by reference to the accompanying drawings forming a part thereof, wherein an example of the invention is shown and wherein.

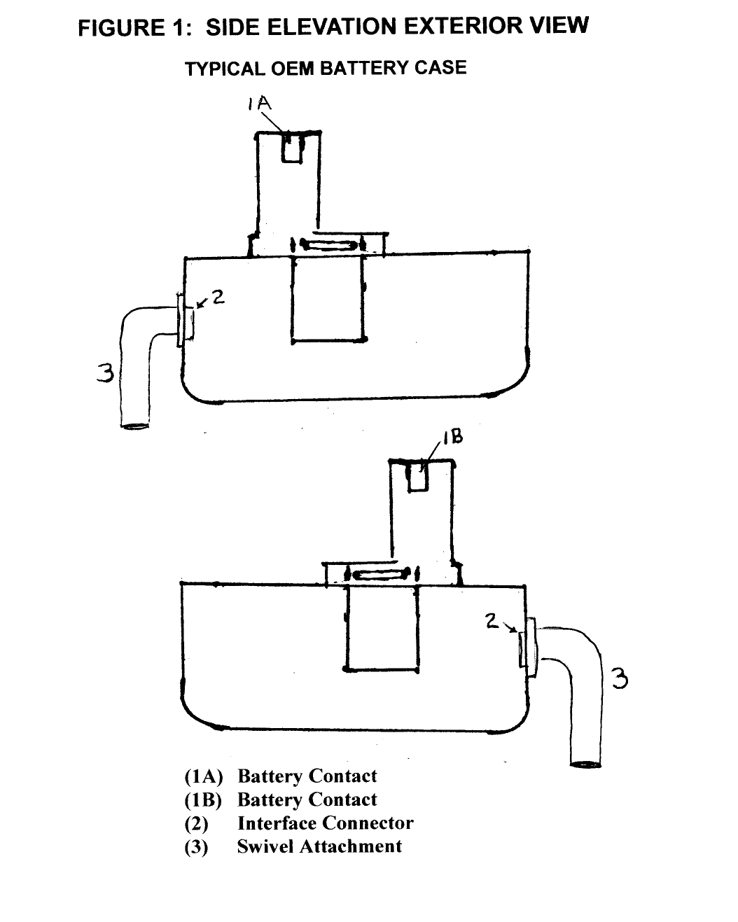

(1) FIG. 1 is a perspective view illustrating the longitudinal and side elevational exterior of power insert device.

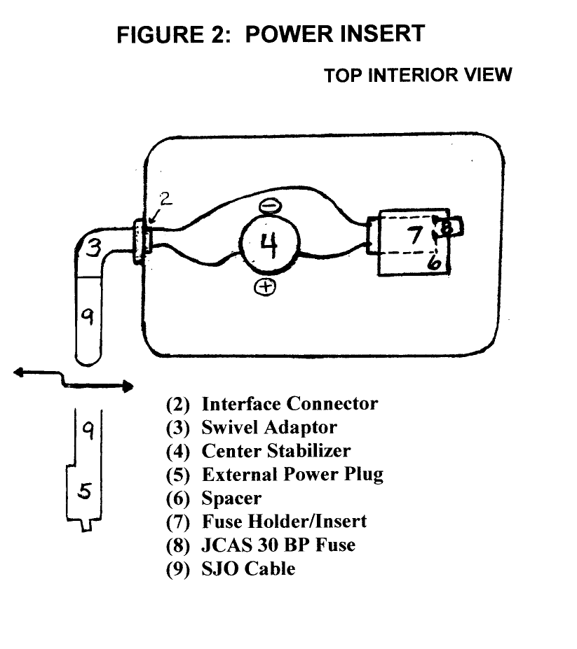

(2) FIG. 2 is a perspective view illustrating the various operating components of the adaptor constructed in accordance with the preferred embodiment of the invention.

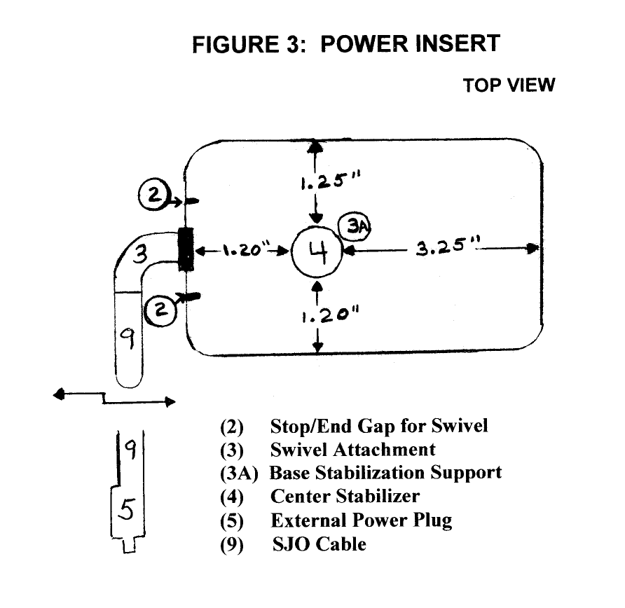

(3) FIG. 3 is a partial longitudinal sectional elevation view of FIG. 2.

### DESCRIPTION OF PREFERRED EMBODIMENT

The subsequent drawings illustrate an adaptor plug and connector for substituting an external battery for internal batteries that supply power to a hand held tool.

FIG. 1 shows an overall drawing of exterior longitudinal and elevated views. The diametrically opposed contacts 1a and 1b thereof, which connect and conform to the confines of the interior battery compartment of the power tool, are electrically connected to the interior of the battery insert device. The interface connector 2, and swivel attachment 3, add to stabilization and ease of use of insert device.

FIG. 2 illustrates battery contacts 1a, 1b, attached to Center Stabilizer 4, secured to base stabilization support 3A (illustrated in FIG. 3), affixed to fuse holder/insert 7, supported and stanchioned by insulated spacer 6, connected through overcurrent protection device 8, returning through interface connector 2, via swivel adapter 3, terminating at external power plug 5.

FIG. 3 depicts top view of battery compartment exterior/interior structural components of battery insert device. Center stabilizer 4, base/stabilization support 3A, are offset for stabilization while providing integral structural strength for 1a/1b battery contacts. Stop/End gap posts 2, allow balanced movement of Swivel attachment 3, for flexibility to external power attachment 5.

What is claimed is:

1. The power insert invention enables users/operators of cordless power tools to accomplish work tasks easier and with less fatigue due to the constant rate of power applied to whatever tool/s are being operated.

2. The power insert invention saves time and money in labor costs by sustaining power at a constant level for extended periods of time. The need to stop progress of your task to remove depleted batteries and replace with freshly charged batteries is eliminated. Batteries supplied with cordless power tools are adequate, but the insert invention provides the essential and continuous power required for the tough jobs, which rapidly reduce original battery strength.

3. The insert invention fits most OEM cordless tools and, when attached to an external battery pack, greatly increases longevity and strength, as opposed to OEM batteries.
